(19) United States
(12) Patent Application Publication
(10) Pub. No.: US 2005/0040577 A1
(43) Pub. Date: Feb. 24, 2005

(54) Method writing data to a large block of a flash memory cell

(75) Inventor: Huang Chiu Fong, Taoyuan Hsien (TW)

Correspondence Address: BACON & THOMAS, PLLC, 625 SLATERS LANE, FOURTH FLOOR, ALEXANDRIA, VA, 22314, US

(73) Assignee: USUN TECHNOLOGY CO., LTD., Taoyuan Hsien (TW)

(21) Appl. No.: 10/642,610

(22) Filed: Aug. 19, 2003

(51) Int. Cl. B25B 11/00

(52) U.S. Cl. 269/21

(57) ABSTRACT

A suction nozzle carrier for use with a vacuum suction apparatus to suck workpieces is disclosed to include a carrier having a plurality of receiving holes connected to the vacuum suction apparatus, and a plurality of suction nozzles respectively mounted in the receiving holes and adapted to suck workpieces upon operation of the vacuum suction apparatus, each suction nozzle having a valve block, a valve element movably mounted in the valve block and adapted to close/open the valve block, and a spring member supporting the valve element in the valve block and adapted to force the valve element to close the valve block.

### BACKGROUND OF THE INVENTION

1. Field of the Invention

The present invention relates to a suction nozzle carrier and, more particularly, to a suction nozzle carrier for use with a vacuum suction apparatus to suck the workpiece for processing, which improves the working efficiency of the vacuum suction apparatus.

2. Description of the Related Art

When transferring or processing light workpiece (papers, circuit boards, rubber films, etc.) in a processing machine, the workpiece must be positively positioned before starting the transferring or processing operation. FIG. 9 shows carton paper suction roll for transferring carton papers. The carton paper suction roll has suction slots cut through the periphery. The suction slots are respectively connected to a vacuum pump so that the workpiece can be secured to the surface of the carton paper suction roll upon the operation of the vacuum pump. This design of carton paper suction roll is still not satisfactory in function. When operating the vacuum pump to suck air, the suction slots that are not covered by the workpiece cannot be held in a vacuum status, and much work of the vacuum pump is in vain. Because work of the vacuum pump is in vain during its operation, the service life of the vacuum pump will be relatively shortened.

Further, according to the utility model, entitled “Transmission Mechanism for Continuous Vacuum Forming Machine”, vacuum suction holes and recessed holes are respectively formed in the upper suction frame and the lower suction frame at locations adjacent to the vacuum tube been connected to a vacuum pump, each vacuum suction hole being mounted with a seal ring; electromagnetic valve means is adapted to control suction and release of the upper suction frame and the lower suction frame. This design enables the fed material to be processed continuously through a continuous series of processing processes including heating, shape forming, and cutting.

The seal rings in the vacuum suction holes of the upper and lower suction frames are shaped like a conventional flexible vacuum mount controlled by the vacuum pump to pick up the workpiece by suction. The use of the seal rings has numerous drawbacks as follows:
1. Movable needles are provided in the seal rings and adapted to support the workpiece, enabling the workpiece to be sucjed by the seal rings. However, if the workpiece has a thin thickness or light weight, or is fragile, it tends to be pierced by the movable needles, thereby causing the seal rings unable to suck up the workpiece.
2. Vacuum suction action is started after the movable needles touched the workpiece and the seal rings closely attached to the worikpiece. If any particular movable needle not touched the workpiece, the upper suction frame or lower suction frame must be provided with a corresponding recessed hole to accommodate the corresponding movable needle. Therefore, this method requires an upper suction frame and a lower suction frame to pick up the workpiece by suction.
3. Because vacuum suction action is started after the movable needles have touched the workpiece and the seal rings have been closely attached to the worikpiece, the upper suction frame or lower suction frame must be provided with recessed holes corresponding to the movable needle, complicating alignment procedure.

### SUMMARY OF THE INVENTION

The present invention has been accomplished under the circumstances in view. It is the main object of the present invention to provide a suction nozzle carrier, which greatly improves the working efficiency of the vacuum suction apparatus. It is another object of the present invention to provide a suction nozzle carrier, which is practical to suck workpieces of different shapes and sizes. To achieve these and other objects of the present invention, the suction nozzle carrier comprises a carrier, which has a plurality of receiving holes, and a plurality of vacuum nozzles respectively mounted in the receiving holes of the carrier in a flush manner and adapted to suck the workpiece upon operation of the vacuum suction apparatus. Each vacuum nozzle comprises a valve block, a valve element movably mounted in the valve block and adapted to close/open the valve block, and a spring member supporting the valve element in the valve block and adapted to force the valve element to close the valve block. The carrier may be provided in any of a variety of forms. For example, the carrier can be made in the form of a roll or work table.

### BRIEF DESCRIPTION OF THE DRAWINGS

FIG. 1 is an elevational view of a suction nozzle carrier according to the present invention.

FIG. 2 is an elevational oblique front view of a suction nozzle for suction nozzle carrier according to the present invention.

FIG. 3 is an elevational oblique rear view of the suction nozzle shown in FIG. 2.

FIG. 4 is an exploded view of the suction nozzle shown in FIGS. 2 and 3.

FIG. 5 is a sectional plain view of FIG. 4.

FIG. 6 is a sectional view in an enlarged scale of a part of the suction nozzle carrier according to the present invention, showing the spring member compressed and the spherical valve element sealed the air passage of the plug cap of the valve block.

FIG. 7 is a sectional view in an enlarged scale of a part of the suction nozzle carrier according to the present invention, showing the workpiece sucked and secured to the surface of the carrier.

FIG. 8 is an elevational view of an alternate form of the suction nozzle carrier according to the present invention.

FIG. 9 is an elevational view of conventional carton paper suction roll.

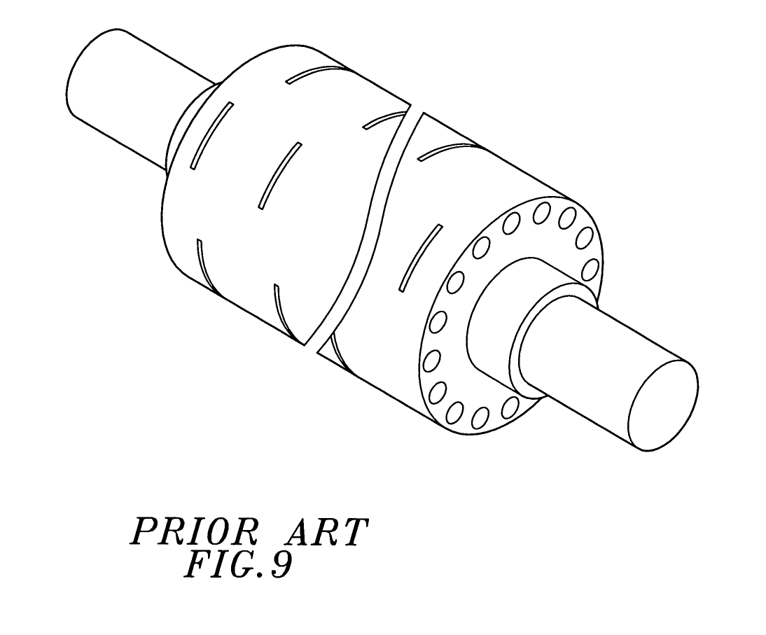

### DETAILED DESCRIPTION OF THE PREFERRED EMBODIMENT

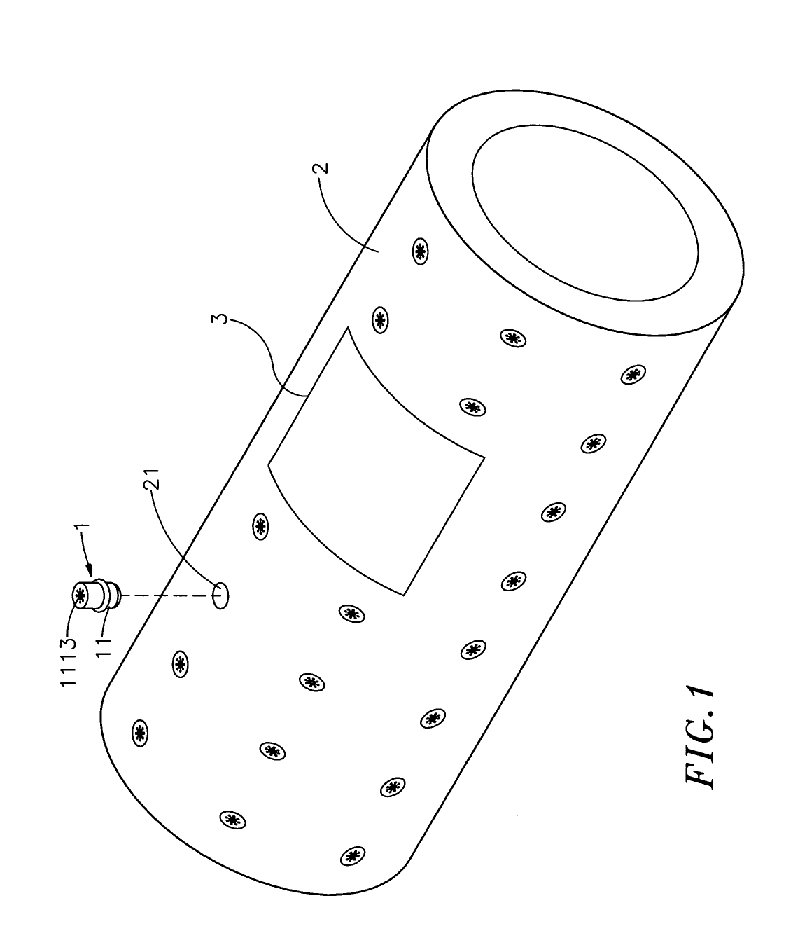

Referring to FIG. 1, a suction nozzle carrier is shown for use with a vacuum suction apparatus (not shown), comprising a carrier 2, and a plurality of suction nozzles 1 mounted in receiving holes 21 in the periphery of the carrier 2 in a flush manner.

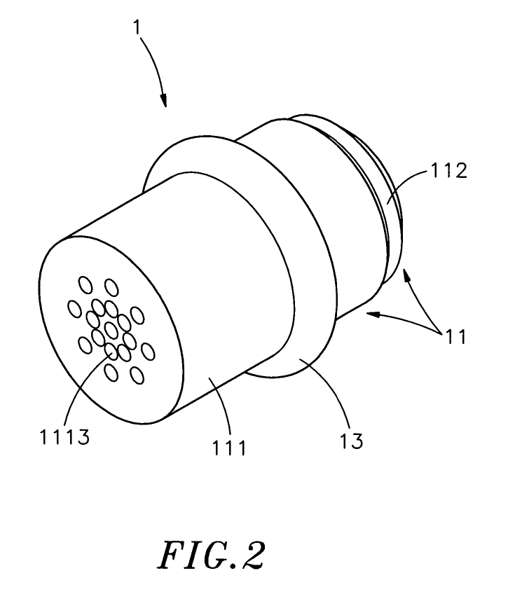

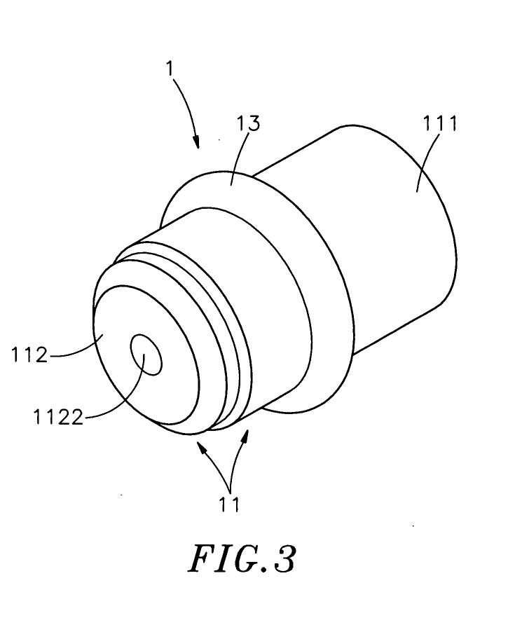

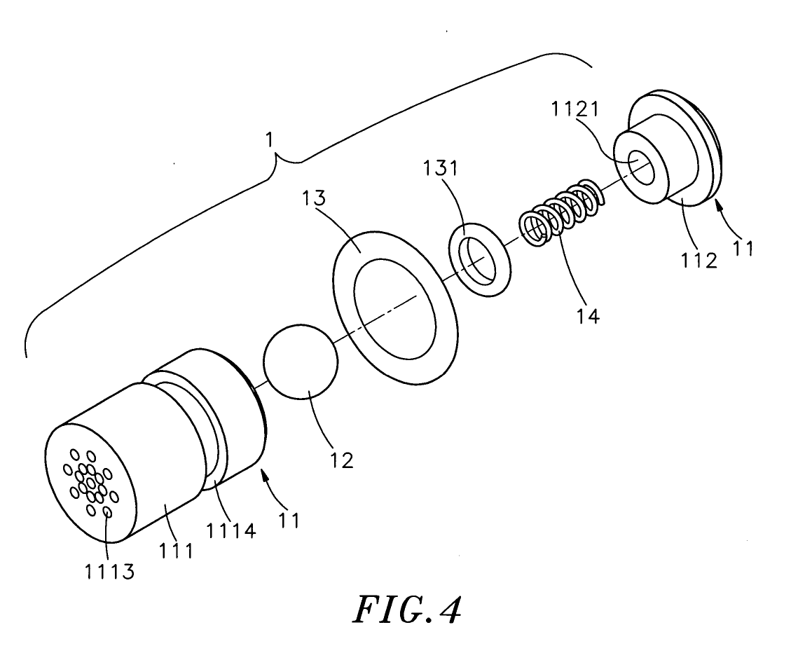

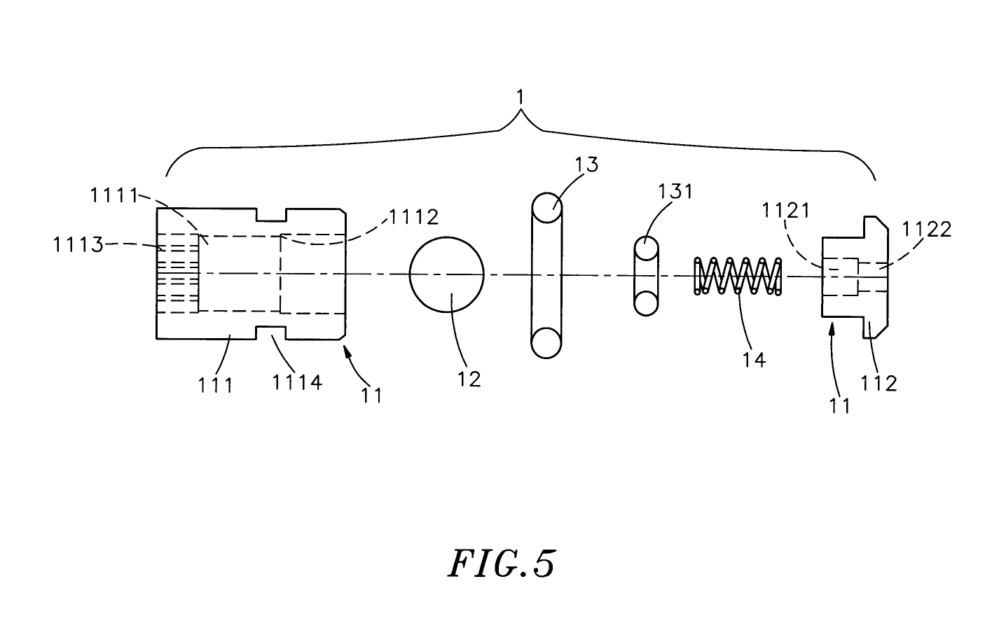

Referring to FIGS. 2-6 and FIG. 1 again, each suction nozzle 1 is comprised of a valve block 11, a spherical valve element 12, an outer gasket ring 13, an inner gasket ring 131, and a spring member 14. The valve block 11 is comprised of a hollow cylindrical shell 111 and a plug cap 112 closing the bottom open side of the hollow cylindrical shell 111. The hollow cylindrical shell 111 comprises a receiving open chamber 1111 axially extended through the bottom side, an annular shoulder 1112 in the periphery of the receiving open chamber 1111, a plurality of air holes 1113 in the top side in communication with the receiving open chamber 1111, an outside annular groove 1114 extended around the periphery. The plug cap 112 is plugged into the receiving open chamber 1111 and stopped outside the bottom side of the hollow cylindrical shell 111, having an axially extended stepped center through hole formed of a big diameter section 1121 and a small diameter section 1122. The big diameter section 1121 is disposed in communication with the receiving open chamber 1111 directly. The spherical valve element 12 is inserted into the receiving open chamber 1111. The outer gasket ring 13 is mounted in the outer annular groove 1114 of the hollow cylindrical shell 111. The inner gasket ring 131 is mounted inside the receiving open chamber 1111 and stopped between the annular shoulder 1112 and the plug cap 112. The spring member14 is mounted in the receiving open chamber 1111, and stopped between the spherical valve element 12 and the connection area (step) between the big diameter section 1121 and the small diameter section 1122.

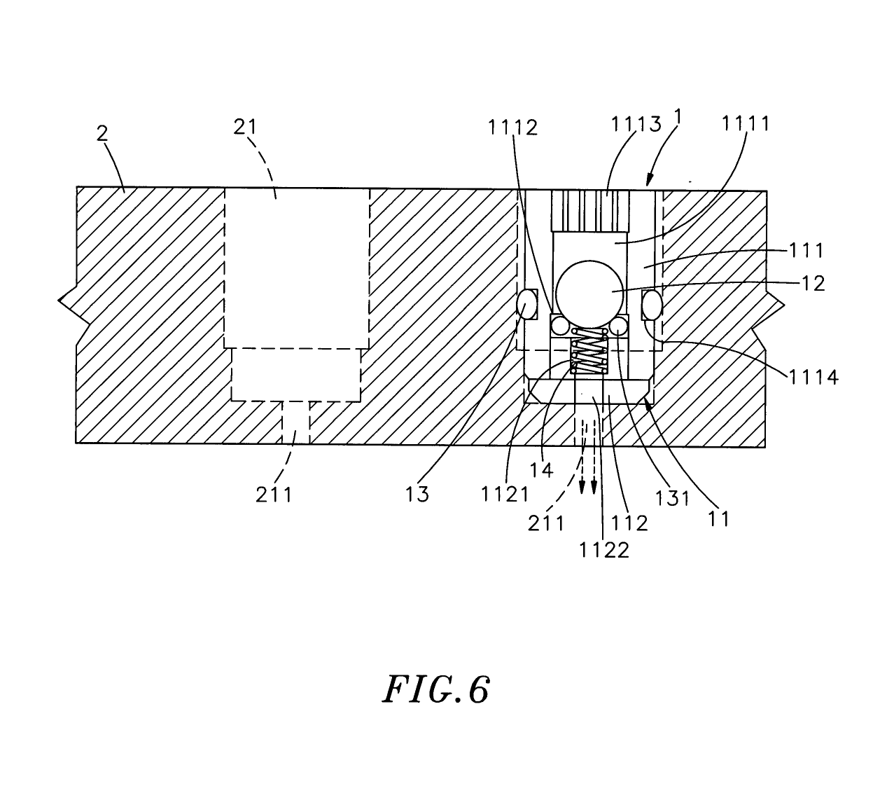

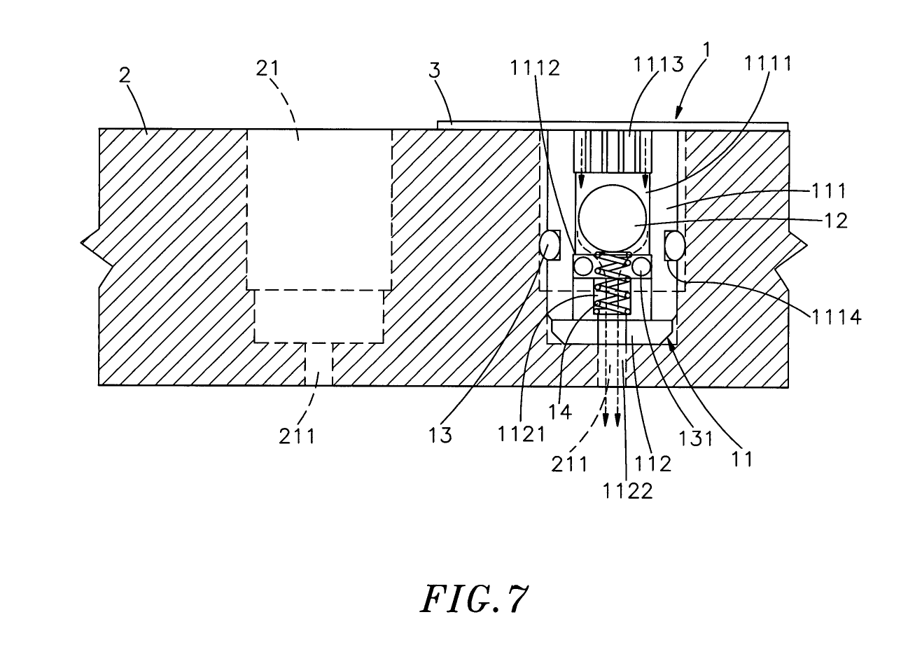

Referring to FIGS. 6 and 7, when the suction nozzles 1 installed in the respective receiving holes 21 of the carrier 2, the axially extended stepped center through the big diameter section 1121 and the small diameter section 1122 of each suction nozzle 1 is disposed in communication with a respective suction hole 211 in the inside wall of the carrier body 2, and the outer gasket ring 13 of each suction nozzle 1 seals the gap between the carrier body 2 and the respective suction nozzle 1.

Referring to FIGS. 1, 6 and 7 again, the carrier 2 according to this embodiment is a roll. When the vacuum suction apparatus does no work, the spring member 14 of each suction nozzle 1 forces the respective spherical valve element 12 to close the air holes 1113 of the respective valve block 11. When the operator places the workpiece 3 on the surface of the carrier 2, the vacuum suction apparatus is started to suck air from the suction holes 211. During the operation of the vacuum suction apparatus, air is drawn away from the air holes 1113 and receiving open chamber 1111 of the valve block 11 of each suction nozzle 1 being covered by the workpiece 3, and therefore the workpiece 3 is sucked and firmly secured to the surface of the carrier 2. When the air holes 1113 of each suction nozzle 1 being covered by the workpiece 3 is airtightly sealed by the workpiece 3, no pressure difference exits, and the spring member 14 supports the spherical valve element 12 at a distance away from the plug cap 112. At the same time, the spherical valve element 12 of each suction nozzle 1 not covered by the workpiece 3 is drawn downwards to compress the respective spring member 14 and the inner gasket ring 131 and to further seal the axially extended stepped center through the big diameter section 1121 and the small diameter section 1122 of the respective suction nozzle 1, preventing continuous suction action at the suction nozzles 1 not covered by the workpiece 3. When the operator removed the workpiece 3 from the carrier 2, the spherical valve elements 12 of the respective suction nozzles 1 are immediately drawn downwards to close the respective valve blocks 11. Therefore, the vacuum suction apparatus works efficiently, saving the consumption of electric energy.

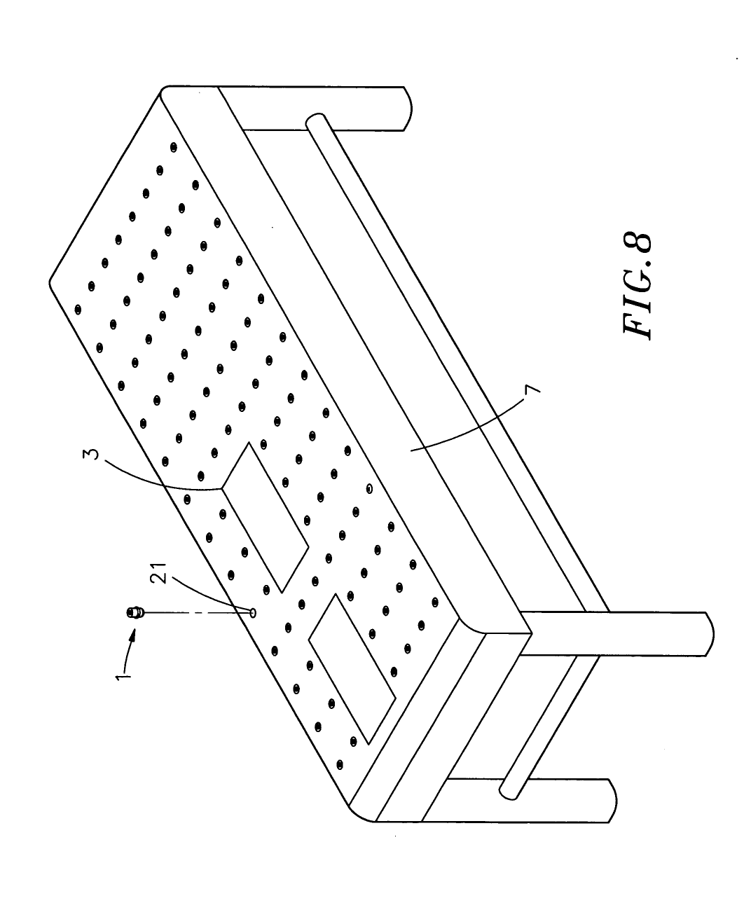

FIG. 8 shows an alternate form of the present invention. According to this embodiment, the carrier 2 is made in the form of a work table, having evenly distributed and vertically extended receiving holes 21, which hold the suction nozzles 1 respectively.

A prototype of suction nozzle carrier has been constructed with the features of FIGS. 1-8. The suction nozzle carrier functions smoothly to provide all of the features discussed earlier.

Although particular embodiments of the invention have been described in detail for purposes of illustration, various modifications and enhancements may be made without departing from the spirit and scope of the invention. For example, the carrier can be made in the form of a conveying device, or in any of a variety of shapes. Accordingly, the invention is not to be limited except as by the appended claims.

1. A suction nozzle carrier for use with a vacuum suction apparatus to suck workpieces, comprising:
a carrier, said carrier having a plurality of receiving holes respectively connected to said vacuum suction apparatus; and
a plurality of vacuum nozzles respectively mounted in said receiving holes in flush with said carrier and adapted to suck workpieces upon operation of said vacuum suction apparatus, said vacuum nozzles each comprising a valve block, a valve element movably mounted in said valve block and adapted to close/open said valve block, and spring members, said spring members supporting said valve element in said valve block and adapted to force said valve element to close said valve block.

2. The suction nozzle carrier as claimed in claim 1, wherein said valve block has a plurality of air holes in a top side thereof.

3. The suction nozzle carrier as claimed in claim 1, wherein said valve block has an outer annular groove extended around the periphery thereof and a gasket ring mounted in said outer annular groove and stopped against the periphery of one receiving hole of said carrier.

4. The suction nozzle carrier as claimed in claim 1, wherein said valve element has a spherical shape.

5. The suction nozzle carrier as claimed in claim 1, wherein said valve block comprises a hollow cylindrical shell, said hollow cylindrical shell having a top close side, a plurality of air holes in said top close side, a bottom open side, and a receiving open chamber disposed in communication between said air holes and said bottom open side and adapted to accommodate said valve element and said spring means, and a plug cap fastened to said bottom open side of said hollow cylindrical shell, said plug cap having an axially extended stepped center through a big diameter section and a small diameter section in communication with said receiving open chamber.

6. The suction nozzle carrier as claimed in claim 5, wherein said valve block further comprises an inner gasket ring mounted inside said hollow cylindrical shell around said spring members and stopped between said plug cap and a part of said hollow cylindrical shell.

7. The suction nozzle carrier as claimed in claim 6, wherein said hollow cylindrical shell has an annular shoulder disposed inside said receiving open chamber and adapted to accommodate said inner gasket ring.

8. The suction nozzle carrier as claimed in claim 1, wherein said carrier is a roll.

9. The suction nozzle carrier as claimed in claim 1, wherein said carrier is a conveying device.

10. The suction nozzle carrier as claimed in claim 1, wherein said carrier is a work table.
